(19) United States
(12) Patent Application Publication
(10) Pub. No.: US 2011/0137764 A1
(43) Pub. Date: Jun. 9, 2011

(54) Method of Applying Multi-Threaded Framework on Online Charging Network Service

(75) Inventors: FENGPING WANG, Nanjing (CN); ZHIQIANG SHAN, Nanjing (CN); BIN LIANG, Nanjing (CN); HUA LI, Nanjing (CN); YOUGEN ZHANG, Nanjing (CN); YAN XIA, Nanjing (CN); JUNHUI SIMA, Nanjing (CN)

(73) Assignee: LINKAGE TECHNOLOGY GROUP CO., LTD., Nanjing (CN)

(21) Appl. No.: 12/962,600

(22) Filed: Dec. 7, 2010

(30) Foreign Application Priority Data
Dec. 9, 2009 (CN) 200910232397.6

(51) Int. Cl. G06Q 10/00

(52) U.S. Cl. 705/30

(57) ABSTRACT

This invention proposes a method of applying multi-threaded framework on online charging network service. Web service process launches listening socket in the service end to wait for connection in the customer end. When the listening socket intercepts connections in the new customer end, the web service process in the service end derives a positive thread, which reads positive data out of the socket and a negative thread, which sends the data to the socket. This invention can ensure that both the positive and negative data in the network interface at any time will be treated on time to fully reduce data transmission delay in the network interface.

### CROSS REFERENCE TO RELATED PATENT APPLICATION

The present application claims the priority of Chinese patent application No. 200910232397.6 filed on Dec. 9, 2009, which application is incorporated herein by reference.

### FIELD OF THE INVENTION

This invention involves in the online charging network service field with the special engagement in the method of applying multi-threaded framework on online charging network service.

### BACKGROUND OF THE INVENTION

As the supplement of traditional offline charging method, the online charging, a.k.a. real-time accounting becomes more and more concentrated by operators because of its characteristics of fully real-time charging, controlling of subscriber defaults and increase users' perception. The OCS system connects the Diameter CC protocol (dcc protocol) interface and core network elements, accepts the charging request of them and returns the core network after the price authorization process conducted by the system to achieve the objective of controlling the subscribers. In the entire process, the performance and stability of the interface of OCS system are especially important, which will impact the charging accuracy and subscriber perceptions.

In the original OCS system, design for the interface service process is in the polling data transmission model, i.e. to read a datum from positive socket, decode it and put it into the request queue inside the OCS system and read a datum from the returned queue of OCS system and then send it to SCP after encoding it in accordance with dcc model. Because there are not necessarily data in each poll of the interface, much air wait is caused. Or sometimes when one side (e.g. the network side) encounters with a sudden of large quantities of data, usually half of the hours will be wasted on processing the message channels with much less data because the system will also take account of the timeliness of the negative message processing. Therefore, the throughput rate of the system will be lowered, which will become the bottleneck of the entire system when the online subscribers are over a million. It will block the message channel in busy hours. In addition, the dcc protocol layering of the original network service is unscientific, which is prone to mistake because any small change in the newly-added transactions will affect the entire scenario.

### SUMMARY OF THE INVENTION

The objective of this invention is to provide a method of applying multi-threaded framework on online charging network service that guarantee the negative and positive data in the network interface can be processed timely at any time to fully reduce the time delay in data network interface.

In order to achieve the aforementioned objective, this invention proposes a method of applying multi-threaded framework on online charging network service. When the socket in the service end listens to connections in the newly established customer end, the network service process in the service end will derive a positive thread which reads and processes positive data from socket and a negative thread which receives and processes negative data and sends them to the socket. The positive thread decodes the positive data while the negative thread encodes the negative data. In this invention, the network service process in the service end will derive a transactional protocol, composed dynamically of IP in the customer end and protocol comparison table. The positive thread and negative thread can transfer the transactional protocol by using positive decoding virtual function interface and negative decoding virtual function interface respectively.

In this invention, when socket is not listening, the positive data processed by positive thread will be inserted into the memory buffer queue of negative thread. In this invention, the customer end communicate with the service end by re-layered and packed dcc protocol, including bottom, middle and transactional package. The bottom one packs various constant definitions and basic operations such as encode and decode; middle one packs various mutual operations in dcc protocol to leave virtual function interface to transactional one; transaction layer packs the virtual function interface in the middle layer.

This invention can ensure both positive and negative data of any socket at any time can be processed timely to fully reduce the time delay in socket, completely address the bottleneck problem of network data transmission in OCS system so as to provide sound guarantee in terms of network service for the following OCS promotion and entire transaction support. In addition, the service end will collocate the protocol flexibly depending on transactional protocol generated by comparison table of local collocation IP and customer IP address as well as protocol numbering. The dcc protocol is further re-layered and packed to strengthen the extensiveness of the protocol and minimize the exploration amount of the newly-added transactions.

### BRIEF DESCRIPTION OF DRAWINGS

FIG. 1 is Organization Chart of Method of Applying Multi-Threaded Framework on Online Charging Network Service

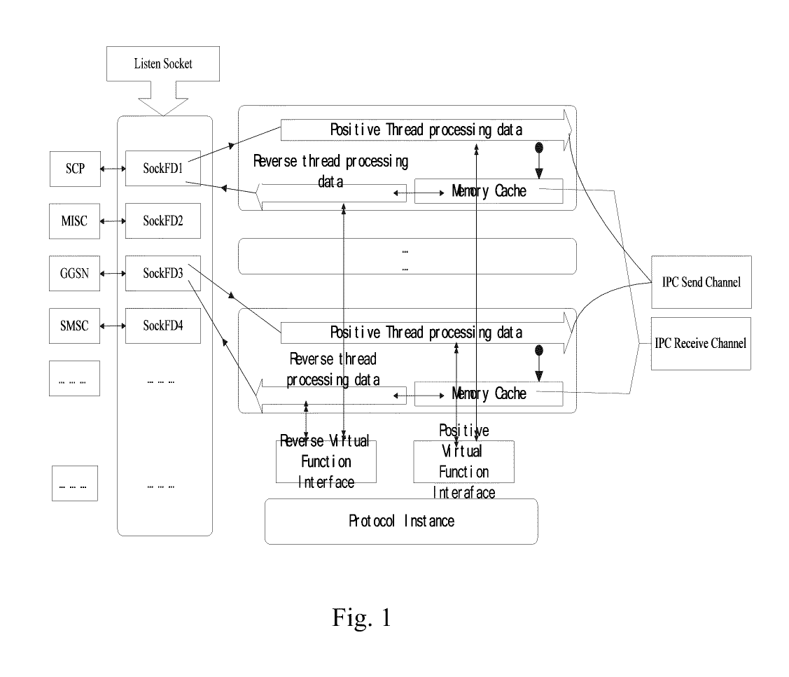

FIG. 2 is Schematic Diagram of Position of Network Service Process in Online Charging System

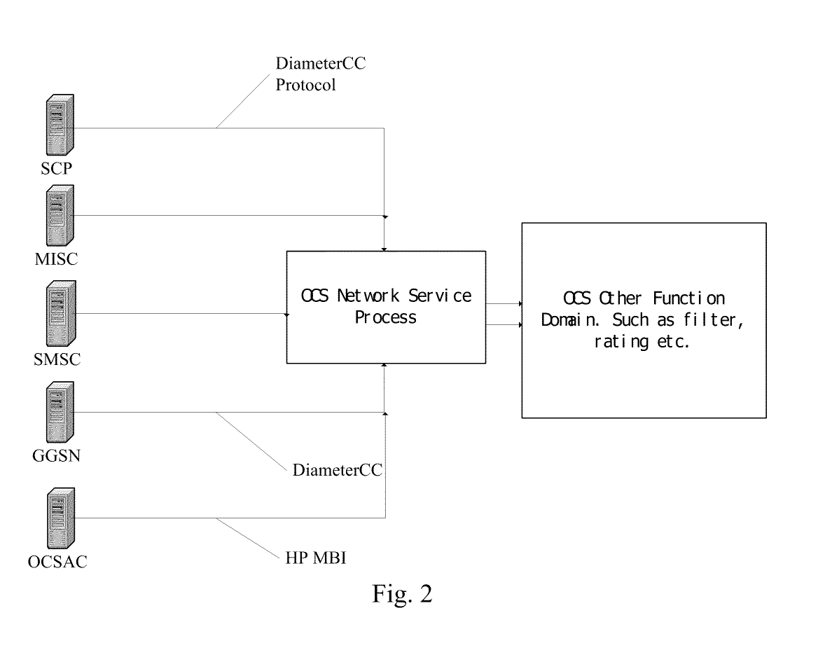

### DETAIL DESCRIPTION OF THE INVENTION

In order to make it easier for the readers to comprehend the aforementioned objective, characteristics and advantages of this invention, the following part of this article lists some suitable examples with affiliated figures to make the detailed descriptions as follows:

FIG. I. is Organization Chart of Method of Applying Multi-Threaded Framework on Online Charging Network Service. As shown in FIG. I. the methods of applying multi-threaded framework on online charging network service can be divided in terms of different functions into socket network service, thread processing data and protocol. The introductions for the aforementioned functions are listed as follows:

### Socket Network Service:

Responsible for accepting and destroying of connections, deriving and destroying of thread;

Responsible for the output of system alerting messages;

Multiple access & concurrency control.

### Thread Processing Data:

Positive thread reads positive data from socket and processes the positive data in accordance with transactional protocols. In this implementation example, positive decoding virtual functions are used in decoding, which is then sent to IPC sending channel;

As for negative data sent from online charging system to SCP, we should determine the socket they belong to before sending them to the memory buffer queue of negative thread of corresponding socket;

Negative thread reads and encodes negative data in the memory buffer and sends the encoded negative data to socket;

As for the processing of special transactions such as automatically replied data or data exempted from listening, the positive data being decoded by positive thread can be directly inserted into the memory buffer queue of the negative thread and be processed in accordance with procedures in the negative processing.

### Protocol:

Function design of protocol interface;

### Protocol Layering Package

When the SCP connection is being established, the procedures of applying multi-threaded framework on online charging network service are as follows:
1. When the process is defending process, open the socket in the corresponding service end to listen after launching the SCP collocation.
2. When the network elements in the customer end connect by TCP/IP, it will be listened by network service process (FIG. II. demonstrates the position of network service process in online charging system). The service end will determine whether the IP address of the customer end is legal. If it is legal, the major thread of the network service process in the service end will derive thread (both positive and negative) and derive protocol for network service in accordance with the IP address from the customer end. If it is illegal, the link will be denied. When the major thread in the network service process has derived resources, operate the thread and continue the listening work. In the mean time, it is responsible for scanning the established TCP connection status and the corresponding thread status, erase the overdue or failed connections and release the corresponding resources.
3. The thread pair derived by the major thread includes a positive thread, a negative thread and a transactional protocol. The positive thread is responsible for reading and decoding positive data from the socket while the negative thread is responsible for processing the negative data and writing the processed negative data into the socket. Because there is only one IPC channel corresponding to the network service process, the negative data will be read by specific thread and sent to the memory buffer queue of various threads in accordance with the recorded socket information in negative data in order to prevent data from being led to the incorrect socket in replying of the system because of multiple negative thread competition. Negative thread reads negative data from memory buffer queue.
4. As for the special data in system processing such as heartbeat data or data exempted from listening, these data will be directly inserted into the memory buffer queue of negative thread after being processed by the positive thread while the negative thread will be processed in ordinary models because there is no need to send them to the following process.
As for network abnormalities, the online charging system provides several abnormalities testing mechanism to ensure to release service resources when network abnormality happens or SCP disconnects. When the abnormalities are detected, the major thread will inform the working thread through bit zone and the working thread will exit from operation if bit zone abnormalities are detected. After exiting from the working thread, the major thread will shut down the corresponding resources in the working thread and erase the derivative transactional protocols.

The core philosophy of this invention is that: the system will open up multi-thread to all network connections to be used specifically in transmission of corresponding data. The network service process of the server will derive two threads for data reading and writing with each newly-established customer connection. In accordance with the direction of data flow, one thread will be responsible for data reading (i.e. positive thread) while the other will be responsible for data writing (i.e. negative thread). By this way, the coincidence and throughput of network data will be guaranteed at the maximum level and the I/O resource in the system will be fully used. As for the concrete transactions, they need to be realized by transference of virtual function interface by thread with the concrete type being determined by IP address in the customer end. In this way, we can designate the corresponding transactional types depending directly on the IP address in the customer end such as SCP, MISC and short message center, etc. We can even support different transactions in the same service process with completely no impact on the mutual encoding and decoding processes or the transmission speed. The specific advantages of this invention are as follows:

1. Solving the Problem of Low Data Transmission Speed

Discard the original poll message transmission model. Data at every direction corresponding to each socket will be processed by specific thread to ensure that data in any direction of any socket at any time can be processed timely to fully reduce the time delay in the network interface. As for some special procedures such as procedures exempted from being listened by the system, they will be decoded by positive thread and determined by the system as listening free status. The directly processed positive data will be inserted into the memory buffer queue of negative thread and processed by negative thread in accordance with ordinary procedures and then replied to the corresponding network elements. The major elements are responsible for accepting connections, deriving threads, alerting output, shutting down connections and terminating threads, etc.

2. Flexible Protocol Collocation

The original network service process only supports single protocol collocation while the new framework can support more flexible protocol collocations. The transactional protocol can be matched depending on the IP address in the customer end. For example, the IP for SCP is IP1 and IP for GGSN is IP2. In the collocation documents in the network service process, IP1 and SCP protocol can be matched for collocation while IP2 and GPRS protocol can be matched for collocation. When IP1 gives a connection request, the service end will generate SCP protocol automatically in accordance with protocol comparison table.

3. Concurrency of Supporting Multiple Protocols Simultaneously

Highly abstract interface is used in the protocol. Guarantee completely irrelevance between data processing and concrete transactional protocols while the related functions will be realized by transferred virtual function interface without caring the concrete transactions at present during thread processing. When the process receives new socket connection, the service end will generate dynamically protocols related to the transaction depending on IP in the customer end, IP in the local collocation and protocol numbering comparison table. One of the obvious advantages of this method is that the protocols transferred by various threads are from their own. There will not be any wait or queue because there is no mutual protocol, which can support concurrency at the maximum level. Another advantage is that the protocol can be any one under the support at present, i.e. the process can process different protocol contents at one time. For example, when the service process is in 4000 interface, through which the SCP can be connected to conduct voice message control, the GGSN can be connected to conduct GPRS data control procedures without any interruption or impact on speed between them.

The concrete implementation cases mentioned in this invention are only relatively good ones in this invention, which are not used to limit the implementation scope of this invention. That is to say, any equivalent changes and modifications in accordance with the contents of patents of this invention should be regarded as the technical scope of this invention.

What is claimed is:

1. A method of applying multi-threaded framework on online charging network service comprising:
when a listening socket intercepts connections in a new customer end, the web service process in a service end derives a positive thread which reads positive data out from the socket and treats such data and a negative thread which sends the processed data to a listening socket.

2. The method of applying multi-threaded framework on online charging network service of claim 1, wherein the web service process at the service end will derive another transactional protocol, which is generated dynamically in accordance with comparison table of IP of customer end and the protocol, the positive thread and negative thread apply positive decoder virtual function interface and negative decoder function interface in distributing business protocols respectively.

3. The method of applying multi-threaded framework on online charging network service of claim 1, wherein when the system is not under surveillance, the information request received by web service process will not be sent to follow-up process of the system and the positive data generated reply message after treatment by positive thread will be inserted into the memory buffer queue of the negative thread.

4. The method of applying multi-threaded framework on online charging network service of claim 1, wherein the positive thread will decode the positive data while the negative thread will encode the negative data.

5. The method of applying multi-threaded framework on online charging network service of claim 1, wherein the customer end and the service end will communicate through re-layer and re-packed dcc protocol, including:
Bottom: pack constants definition and basic operations such as CODEC;
Middle: pack mutual operation of dcc, leave virtual function interfaces of business treatment.
